(19) United States
(12) Patent Application Publication
(10) Pub. No.: US 2009/0065115 A1
(43) Pub. Date: Mar. 12, 2009

(54) Pneumatic tire with decoupling groove

(75) Inventor: Daniel Stephen Mathews, Jasper, AL (US)

Correspondence Address: CONTINENTAL TEVES, INC., ONE CONTINENTAL DRIVE, AUBURN HILLLS, MI, 48326-1581, US

(73) Assignee: Continental Tire North America, Inc.

(21) Appl. No.: 11/900,388

(22) Filed: Sep. 11, 2007

(51) Int. Cl. B60C 11/01

(52) U.S. Cl. 152/209.16

(57) ABSTRACT

A tire tread has a decoupling groove (32) with walls (20, 22) that have a wavy shape in the radial direction with respect to the tire geometry, i.e. at least one axial deviation (26, 28) along the depth of the decoupling groove (18). An axial cut through the tire tread (10) divulges a wavy course of the decoupling groove (18), where the two walls (20, 22) have contours that complement each other. During a road contact of a respective tread section, the decoupling groove (18) closes, and a radially interlocking connection between the shoulder rib (12) and the decoupler rib (14) is made.

Under load, the decoupler rib (14) functions like a part of the tread (10), thus protecting the shoulder rib (12) from erosion wear.

### BACKGROUND OF THE INVENTION

The present invention relates to a tire tread with a circumferential decoupling groove as commonly used on truck steer tires or on other non-drives axles, for instance on trailers.

The use of treads specifically designed for the steer axle of truck tires has been directed to various forms of rib-type tires. This non-driving axle exhibits cornering and turning loads as well as straight line running loads.

High wear erosion is common in the shoulder region of the tread. In order to reduce irregular wear, the use of a laterally located circumferentially continuous rib, a so-called decoupler rib, has been suggested that under normal driving conditions is in contact with the road, the force or pressure exerted by the decoupler rib on the road being less than the force or pressure of the shoulder rib. This kind of tire relies on the decoupler rib to protect the outer edge of the shoulder rib. The slightly recessed decoupler rib is to be in contact with the road surfaces when in normal running conditions, the decoupler rib exhibiting less pressure than shoulder rib. The decoupling groove separating the decoupler rib from the shoulder rib typically has nearly parallel walls leading straight up to the edge of the shoulder rib on the one hand and to the edge of the decoupler rib on the other hand.

A similar decoupler rib has been suggested in U.S. Pat. No. 5,550,652 with the difference that the radially shorter decoupler rib will not make contact with the road under normal driving conditions.

U.S. Pat. No. 6,488,062 describes a tire with a decoupler rib as well. The edge of the tread rib adjoining the decoupling groove is provided with numerous small sipes that open into the decoupling groove. The intended effect is to further reduce erosive shoulder wear, also called shoulder river wear, tramline wear, or step-off wear, which causes the rib edges to deteriorate and to become irregular and blunt. The sipes are arranged at an angle with respect to the tire's axial direction as well as its radial direction, thus rendering the tire a directional tire.

As decoupler ribs are disconnected from the tread, any wear on the decoupler rib cannot expand past the decoupling groove. However, the protection of the shoulder rib itself is often not fully satisfactory because the axial and circumferential forces on the shoulder rib are much higher than the forces picked up by the decoupler rib, even if the decoupler rib makes contact with the road surface.

It is therefore the objective of the present invention to provide a tire tread with a decoupling groove and a decoupler rib which reduces irregular wear on the shoulder rib.

### SUMMARY OF THE INVENTION

This objective is achieved by a tire tread with a decoupling groove having walls that have a wavy shape in the radial direction with respect to the tire geometry, i.e. at least one axial deflection along the depth of the decoupling groove. An axial cut through the tire tread divulges a wavy course of the decoupling groove, where the two walls have preferably deflections that complement each other. By this means, a road contact, during which the decoupling groove closes, will effect an interlocking connection between the shoulder rib and the decoupler rib.

This arrangement allows the decoupler rib to act as a part of the working tread in the area of the tire footprint. The decoupler rib is prevented from radially shifting with respect to the shoulder rib and is consequently held in contact the road surface. Thus the decoupler rib will bear more load in the footprint area than in previous tire designs. Instead of the shoulder rib, now the decoupler rib attracts such forces that cause irregular wear.

A rounded bottom of the decoupling groove with a widened bottom section radius, e.g. a tear-drop-shaped bottom, will prevent cracks in the bottom of the decoupling groove.

The same principle can be applied to sipes that may be added to the tread along the outer edge of the shoulder rib.

Further details will be evident from the following description of an embodiment by hand of a drawing.

### BRIEF DESCRIPTION OF THE DRAWINGS

In the drawings,

FIG. 1 is a schematic cross-sectional partial view of a tire according to the present invention.

### DETAILED DESCRIPTION OF THE DRAWINGS

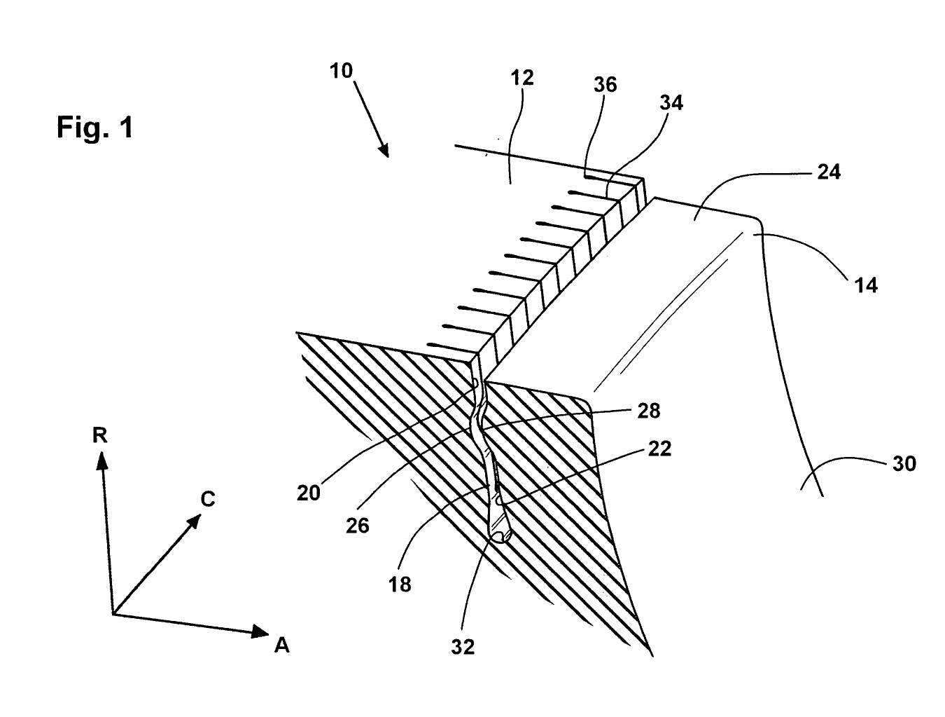

With reference to FIG. 1, a partial radial cross section of the pneumatic radial tire, for example for use on steering axles or trailer axles, is illustrated.

The tire tread 10 comprises a shoulder rib 12 extending in the circumferential direction C of the tire and a decoupler rib 14 extending in parallel thereto, separated from each other by a decoupling groove 18. The wall 20 connecting the decoupling groove 18 with the shoulder rib 12 is approximately 1.5 mm higher than the wall 22 connecting the decoupling groove 18 with the decoupler rib 14. Accordingly, the radially outer surface 24 of the decoupler rib 14 is slightly radially recessed in comparison with the shoulder rib 14.

While in the circumferential direction C the walls 20 and 22 take a straight course around the tire, they have a wavy contour in the radial direction R with respect to the tire geometry, i.e. an axial deviation over the course of the depth of the decoupling groove. In the shown example, wall 20, which is connected to the shoulder rib 12, has an annular axial indentation. Wall 22, associated with the decoupling groove 14, has a matching complementary annular axial elevation. If so desired, there can be a continuous wavy contour or axial deviations toward the tire sidewall 30 as opposed to the shown deviations 26 and 28 toward the axial center of the tire.

River wear mostly occurs during the first 60,000 miles of a tire life. After that, further preventive measures become unnecessary. Therefore, the wavy contour of the walls 20 and 22 is located closer to the tread surface of the tire than toward the bottom 32 of the decoupling groove 18. Once the tread is worn down by a significant amount, the wavy contour becomes unnecessary and, in this case, is worn away.

When a respective tread section is under load, the tread surface of the shoulder rib 12 will nearly align with the surface of the decoupler rib 14 due to the depression of the tread, and the gap of the decoupling groove will close so that the wavy contours 26 and 28 interlock. Thus decoupler rib acts as a part of the working tread in the area of the tire footprint, thereby protecting the shoulder rib from erosion wear. The decoupler rib 14 itself has a lightly tapered outer edge to reduce erosion wear along this edge.

To prevent tears, the bottom 32 of the decoupling groove 18 has a teardrop-shaped bottom contour. The bottom 32 is curved with a diameter approximately twice as large as the width of the decoupling groove 18 when the tread portion is not under load. This prevents tearing and cracking of the bottom 32 of the decoupler groove 18 while still allowing an easy removal of the tire from its mold.

Along its outer edge, the shoulder rib 12 is equipped with numerous sipes 34, which are arranged at substantially equal distances from each other along the entire circumference of the tire tread 10. Should the shoulder rib 12 suffer some erosion damage on its outer edge, the spread of this damage is disrupted by the adjacent sipes, and the damage remains localized. Similar to the decoupling groove, the sipes have rounded bottoms 36 to prevent the tread from tearing inside the sipes. The diameter of the rounded bottoms 36 is about twice the width of the shoulder sipes 34.

In the example shown, the shoulder sipes 34 have a radial depth of roughly three quarters of the decoupler groove 18. The shoulder sipes 34 are approximately 0.5 mm wide, while the decoupling groove 18 is approximately 1 to 2 mm wide. The shoulder sipes are spaced apart by approximately 3 to 5 mm. The width of the decoupler rib at its radially outer surface 24 amounts to approximately 10 mm, and the decoupler rib is radially recessed with respect to the shoulder rib by approximately 1.5 mm.

It is evident that a substantial deviation from these measurements, will still bring about the intended benefits of the invention. This applies to the width of the decoupling groove, the decoupler rib and the shoulder sipes and to the recess of the decoupler rib with respect to the shoulder rib as well as to the diameter of the bottom of the decoupling groove and the shoulder sipes.

What is claimed is:

1. A pneumatic tire with a tread (10) comprising a shoulder rib (12) extending in circumferential direction and separated from a circumferentially extending decoupler rib (14) by means of a decoupling groove (18) with two walls (20,22), one of which (20) connects the decoupling groove (18) with the shoulder rib (16) and the other one of which (22) connects the decoupling groove (18) with the decoupler rib (14), Wherein each of the walls (20,22) has at least one axial deviation (26, 28) over the radial course of the depth of the decoupling groove.

2. The tire according to claim 1, wherein the at least one deviation (26) of one of the walls (20) complements the at least one deviation (28) of the other one of the walls (22).

3. The tire according to claim 1, wherein the decoupler rib (14) is recessed from the shoulder rib (12) by an amount that will result in a road contact under load.

4. The tire according to claim 3, wherein the decoupler rib (14), at its radially outer surface (24), has an axial width of no less than 6 mm.

5. The tire according to claim 1, wherein the bottom of the decoupling groove (18) is rounded with a diameter of approximately 2 mm.

6. The tire according to claim 1, wherein the shoulder rib (12) has an outer edge with a plurality of substantially equidistant sipes (34).

7. The tire according to claim 6, wherein the sipes (34) have rounded bottoms (36) with a diameter approximately twice as large as the width of the sipes (34).
